(19) United States
(12) Patent Application Publication
(10) Pub. No.: US 2009/0180172 A1
(43) Pub. Date: Jul. 16, 2009

(54) Electrophoretic Display Medium, Electrophoretic Display Medium Manufacturing Method, and Electrophoretic Display Device

(76) Inventor: Kenichi Murakami, Kuwana-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/390,998

(22) Filed: Feb. 23, 2009

Related U.S. Application Data
(63) Continuation-in-part of application No. PCT/JP2007/064476, filed on Jul. 24, 2007.

(30) Foreign Application Priority Data
Aug. 22, 2006 (JP) 2006225481

(51) Int. Cl. G02F 1/167; B28B 1/14; B29C 35/08

(52) U.S. Cl. 359/296; 264/299; 264/496

(57) ABSTRACT

An electrophoretic display medium manufacturing method for manufacturing an electrophoretic display medium that includes a first substrate and a second substrate that are provided such that they face one another, the electrophoretic display medium manufacturing method including the steps of forming a first substrate such that it conforms to recessed and protruding portions of a forming surface provided in a forming die, the first substrate being formed from a synthetic resin, forming partition walls that are projecting portions to partition a space sandwiched between the first and the second substrate into a plurality of cells, and forming electrode films in non-wall portions that are parts of the inner face of the first substrate where the partition walls are not formed, such that the electrode films will apply an electrical field for moving charged particles enclosed within the cells.

### CROSS REFERENCE TO RELATED APPLICATION

The present application is a continuation-in-part application of International Application No. PCT/JP2007/064476, which was filed on Jul. 24, 2007, and which claims priority from Japanese Patent Application No. JP-2006-225481, which was filed on Aug. 22, 2006. The disclosures of the foregoing applications are hereby incorporated by reference in their entirety.

### BACKGROUND OF THE INVENTION

The present disclosure relates to an electrophoretic display medium, an electrophoretic display medium manufacturing method, and an electrophoretic display device. Specifically, the present disclosure relates to an electrophoretic display medium in which a dispersion system that contains charged particles is enclosed within a plurality of separate cells that are separated by partition walls, an electrophoretic display medium manufacturing method, and an electrophoretic display device.

The electrophoretic display medium has been known for some time as a medium for displaying an image. The electrophoretic display medium includes a pair of substrates, comprised of a first substrate that serves as one of a transparent and translucent display surface and a second substrate that is positioned opposite the first substrate, with the space between the paired substrates filled with a dispersion medium that contains charged particles. The dispersion medium is sandwiched between opposing electrodes, and the charged particles can be moved toward one of the first substrate and the second substrate by a voltage that is applied to the electrodes. In a case where the charged particles and the dispersion medium have different colors, a user can see the color of the charged particles from the display surface side when the application of the voltage causes the charged particles to move toward the first substrate, which serves as the display surface. In contrast, when the charged particles move toward the second substrate, the color of the dispersion medium can be seen from the display surface side. Any sort of image can be displayed by using this sort of electrophoretic display medium to display a different color for each pixel.

In a case where the entire electrophoretic display medium is a single cell and the charged particles are moved, the charged particles cluster together in the dispersion medium that fills the interior of the electrophoretic display medium, such that when they are moved horizontally, the charged particles do not move uniformly, which causes display irregularities. Therefore, partition walls are generally formed on the substrates, such that the space between the substrates is divided into a plurality of cells. Enclosing the charged particles within the individual cells restricts the clustering of the charged particles and their horizontal movement. The method by which the partition walls are formed is a method in which the substrates are coated a photosensitive material and the partition walls are formed by photolithography. However, it is difficult with this method to ensure adhesion between the substrates and the partition walls, and the partition walls may separate from the substrates.

To address this issue, an electrophoretic display medium and an electrophoretic display medium manufacturing method have been proposed in which a partition wall material is pressed onto the substrates by spattering (Japanese Laid-Open Patent Publication No. 2001-343672). According to the method, the substrates and the pattern walls are formed as a single unit, so it is possible to avoid the problem of the partition walls separating from the substrates.

However, in the electrophoretic display medium that is described in Japanese Laid-Open Patent Publication No. 2001-343672, an electrode that is provided on the substrate on which the partition walls are formed is formed on the opposite face of the substrate from the face on which the partition walls are formed. This increases the distance between the opposing electrodes, creating a problem in that a higher voltage must be applied to move the charged particles.

### SUMMARY OF THE INVENTION

The present disclosure addresses the problem described above and provides an electrophoretic display medium that has partition walls that do not readily separate from the substrates and that also limits the voltage that is applied to the electrodes, an electrophoretic display medium manufacturing method, and an electrophoretic display device.

To solve the problems described above, according to a first aspect of the present disclosure, an electrophoretic display medium manufacturing method for manufacturing an electrophoretic display medium that includes a first substrate and a second substrate that are provided such that they face one another, the electrophoretic display medium manufacturing method including the steps of forming an unprocessed first substrate such that it conforms to recessed and protruding portions of a forming surface that is provided in a forming die, the unprocessed first substrate being formed from a synthetic resin and the forming die being pressed upon at least an inner face of the unprocessed first substrate, the inner face being a surface that faces the second substrate; forming partition walls that are projecting portions that are provided on the inner face to partition a space that is sandwiched between the first substrate and the second substrate into a plurality of cells, the partition walls being formed by releasing the forming die from the first substrate; and forming electrode films in non-wall portions that are parts of the inner face of the first substrate where the partition walls are not formed, such that the electrode films will apply an electrical field for moving charged particles that are enclosed within the cells.

To solve the problems described above, according to a second aspect of the present disclosure, an electrophoretic display medium that is manufactured by one of the electrophoretic display medium manufacturing methods described above.

To solve the problems described above, according to a third aspect of the present disclosure, an electrophoretic display device, including the electrophoretic display medium described above.

Other objects, features, and advantage will be apparent to persons of ordinary skill in the art from the following detailed description of the invention and the accompanying drawings.

### BRIEF DESCRIPTION OF THE DRAWINGS

For a more complete understanding of the present invention, the needs satisfied thereby, and the features and technical advantages thereof, reference now is made to the following descriptions taken in connection with the accompanying drawings.

FIG. 1 is a perspective view that shows an external appearance of an electrophoretic display medium that is included in an electrophoretic display device;

FIG. 2 is an exploded perspective view that shows main portions of the electrophoretic display medium;

FIG. 3 is a view of a cross section of the electrophoretic display medium at a line I-I shown in FIG. 1;

FIG. 4 is a view of a cross section of the electrophoretic display medium at a line II-II shown in FIG. 3;

FIG. 5 is an explanatory figure that shows a state in which a black color is displayed over an entire display area of a display surface of a first substrate;

FIG. 6 is an explanatory figure that shows a state in which a white color is displayed over the entire display area of the display surface of the first substrate;

FIG. 7 is an explanatory figure that shows a state in which the first substrate, partition walls, and a spacer are formed in a partition wall formation process;

FIG. 8 is an explanatory figure that shows a state in which a common electrode is formed on an inner face of the first substrate in an electrode film formation process;

FIG. 9 is an explanatory figure that shows a state in which, in a dispersion fluid injection process, a dispersion fluid is injected into a plurality of cells that are concave portions that are formed by the partition walls;

FIG. 10 is an explanatory figure that shows a state in which a second substrate is attached to the first substrate in a second substrate attachment process;

FIG. 11 is an explanatory figure for explaining a synthetic resin that is placed in a press device with a heating structure in a press forming process within a partition wall formation process of a first embodiment;

FIG. 12 is an explanatory figure for explaining a formed surface of a forming die that corresponds to the cross section surface that is shown in FIG. 4;

FIG. 13 is an explanatory figure for explaining a state in which a synthetic resin that contains a thermoplastic resin is formed by pressing in a press forming process within the partition wall formation process of the first embodiment;

FIG. 14 is an explanatory figure for explaining a die release process within the partition wall formation process of the first embodiment;

FIG. 15 is an explanatory figure that shows a state in which a resist film is formed on the inner face of the first substrate in a resist film formation process, such that the resist film covers the partition walls and the spacer;

FIG. 16 is an explanatory figure for explaining a lithographic exposure process that, by irradiating with light the resist film that was formed in the resist film formation process, causes the resist film on outer edge portions of the spacer and the partition walls, which are protruding portions that are formed on the inner face of the first substrate by the die release process, to assume a state in which the resist film cannot be dissolved by a developing fluid;

FIG. 17 is an explanatory figure that shows a state in which the resist film, except for the resist film that was put into the insoluble state by the lithographic exposure process, has been removed by a development process;

FIG. 18 is an explanatory figure that shows a state in which, in an electrically conductive film formation process, a common electrode has been formed in the portions of the first substrate where the partition walls were not formed and the resist film was removed by the development process, and an electrode film has been formed on the surface of the resist film that remains on the outer edge portions of the partition walls after the development process;

FIG. 19 is an explanatory figure that shows a state in which, after the electrically conductive film formation process, the resist film that remained on the outer edge portions of the partition walls after the development process and the electrode film that was formed on the resist film have been removed;

FIG. 20 is a view of the partition walls according to the first embodiment that corresponds to the partial cross section view that is shown in FIG. 4;

FIG. 21 is a view of partition walls according to a second embodiment that corresponds to the partial cross section view that is shown in FIG. 4;

FIG. 22 is a view of partition walls according to a third embodiment that corresponds to the partial cross section view that is shown in FIG. 4;

FIG. 23 is an explanatory figure for explaining a sand blasting process according to the second embodiment; and

FIG. 24 is an explanatory figure that shows a state in which a resist film has been formed on outer edge portions of partition walls in a resist coating process according to the third embodiment.

### DETAILED DESCRIPTION OF THE EXEMPLARY EMBODIMENTS

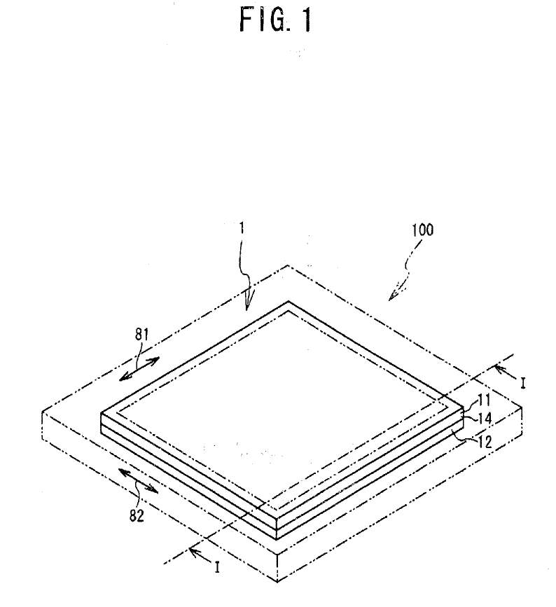

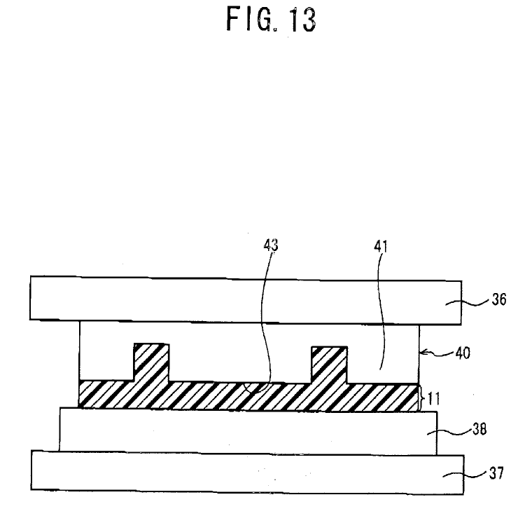

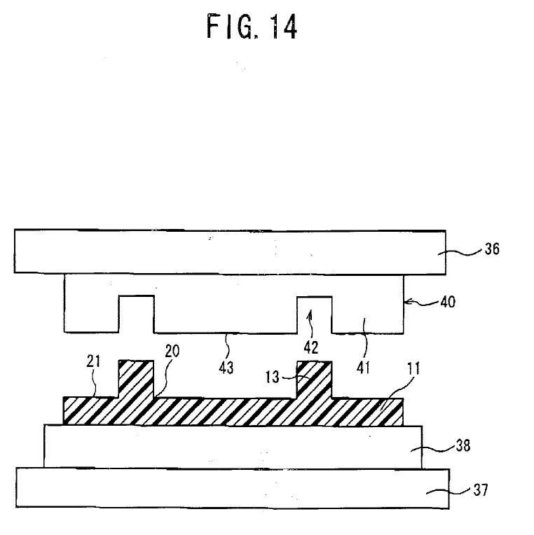

Embodiments of the present invention and their features and technical advantages may be understood by referring to FIGS. 1-24, like numerals being used for like corresponding portions in the various drawings.

Hereinafter, an exemplary embodiment of an electrophoretic display medium 1 that reduces to practice an electrophoretic display medium according to the present disclosure will be explained with reference to the attached drawings. The electrophoretic display medium 1 that illustrates the present embodiment by example is a compact display panel that is suitable for use in an electrophoretic display device 100 such as a portable electronic device or the like.

First, a configuration of the electrophoretic display medium 1 according to the embodiments of the present disclosure will be explained with reference to FIGS. 1 to 4.

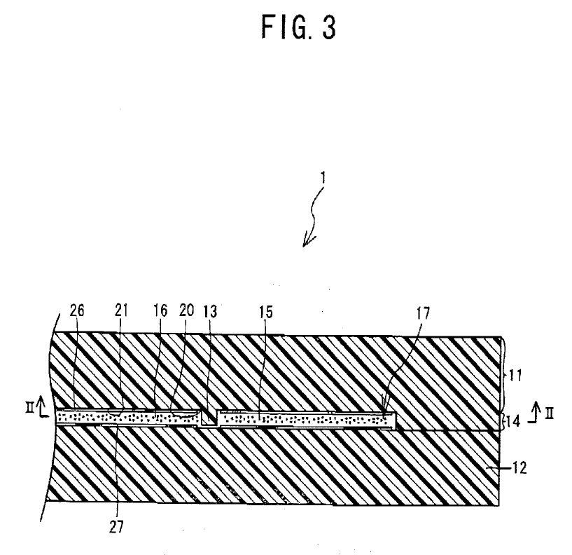

As shown in FIGS. 1 to 3, the electrophoretic display medium 1 that is provided in the electrophoretic display device 100 contains a first substrate 11 and a second substrate 12 that are positioned opposite one another with a spacer 14 between them. A plurality of partition walls 13 is provided on a face (an inner face) of the first substrate 11 that faces the second substrate 12. The partition walls 13 partition the space that is sandwiched between the first substrate 11 and the second substrate 12 into a plurality of cells 17. As shown in FIG. 3, a dispersion fluid is enclosed between the first substrate 11 and the second substrate 12. The dispersion fluid includes a dispersion medium 16 and a plurality of charged particles 15. In the present embodiment, the first substrate, the partition walls 13, and the spacer 14 are formed as a single unit. Various configuring elements of the electrophoretic display medium 1 will be described in detail below.

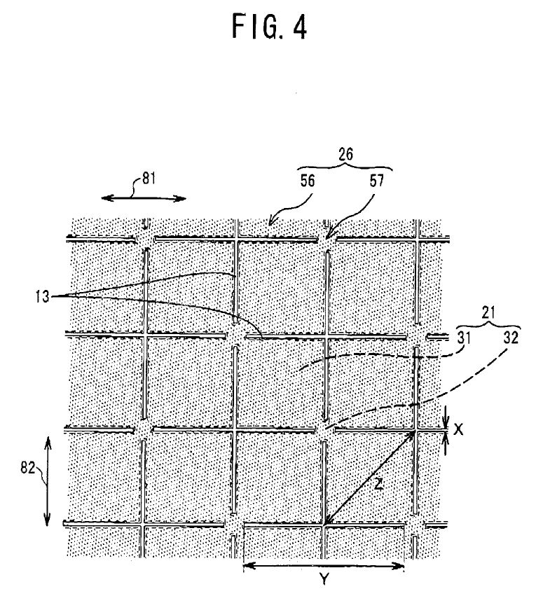

The first substrate 11 is a sheet-shaped substrate with a specified thickness that has a display surface that displays an image that is formed in pixel units. The thickness of the first substrate 11 can be set to suit the material, the intended purpose, and the like of the electrophoretic display medium 1 and may be, for example, 300 micrometers. On an inner face 20 of the first substrate 11 that faces the second substrate 12, areas where the partition walls 13 are not formed are non-wall portions 21. As shown in FIG. 4, the non-wall portions 21 include cell portions 31 and connecting portions 32. The cell portions 31 are demarcated by the partition walls 13. The connecting portions 32 electrically connect adjacent electrode films 56 that are provided in the cell portions 31. The partition walls 13 are not formed in the connecting portions 32.

The partition walls 13 and the spacer 14 of the first substrate 11 are formed as a single unit from a synthetic resin, preferably a stimulus hardening resin that is hardened by an external stimulus. The external stimulus that is a condition for the hardening of the stimulus hardening resin may be heat, light such as ultraviolet light or the like, oxygen, mixing (stirring), or the like. The stimulus hardening resin that is used may be a thermosetting resin that is hardened by heating, a thermoplastic resin that is hardened by cooling, an ultraviolet light hardening resin that is hardened by irradiating it with ultraviolet light, or the like. The stimulus hardening resin that is used may also be a resin that is hardened by being exposed to oxygen, a resin that is hardened by mixing (stirring) of resin materials, or the like. A thermosetting resin that is used may be an epoxy resin, a phenol resin, a melamine resin, an unsaturated ester resin, or the like. A thermoplastic resin that is used may be any resin that is hardened by cooling. Specifically, polymethyl methacrylate (PMMA), polyethylene terephthalate (PET), polyethylene naphthalate (PEN), cyclo-olefin polymer (COP), polyethylene (PE), polypropylene (PP), polyethersulfone (PES), and the like may be used, for example. In a case where an ultraviolet light hardening resin is used, an epoxy resin, a urethane resin, an acrylate resin, or the like may be used. Note that in addition to a case in which the entire first substrate 11 is formed from a synthetic resin such as a stimulus hardening resin or the like, as it is in the present embodiment, it is also acceptable for only a portion of the first substrate 11 to be formed from a synthetic resin. In that case, a synthetic resin such as a stimulus hardening resin or the like must be provided on at least the inner face of the first substrate 11 that faces the second substrate 12.

In contrast, the second substrate 12 does not necessarily have to be transparent, because it is not the substrate on the side where the display surface is located. Accordingly, the second substrate 12 may be formed using a transparent material and may also be formed using a material that is not transparent, such as stainless steel, aluminum, or the like, for example, and that is provided with an insulating layer on its surface. Note that in the electrophoretic display medium 1 that is shown in FIG. 3, the second substrate 12 is shown as being formed from a resin material such as a polyimide resin, a polypropylene resin, a polyethylene resin, or the like, but the second substrate 12 is not limited to this example.

The spacer 14 is formed around an outer edge portion of the first substrate 11. The spacer 14 holds the first substrate 11 and the second substrate 12 with a specified interval between them and also provides a seal such that the dispersion medium 16 and the charged particles 15, which are described later, do not leak to the outside. In the present embodiment, the spacer 14 maintains an interval of 25 micrometers between the first substrate 11 and the second substrate 12. The width of the spacer 14 can be set to suit the material, the intended purpose, and the like of the electrophoretic display medium 1 and may be, for example, 1 millimeter. The spacer 14 is formed as a single unit with the first substrate 11 and the partition walls 13 from the stimulus hardening resin described above. Note that it is also acceptable for the spacer 14 not to be formed as a single unit with the first substrate 11 and the partition walls 13. In that case, the spacer 14 may be formed on the inner face 20 of the first substrate 11 using an epoxy resin, an acrylic resin, or the like. Therefore, although a case is shown in FIG. 3 in which the spacer 14 is formed from a resin material, the spacer 14 is not limited to this example, and various types of materials can be used.

The dispersion medium 16 is a solvent for dispersing the charged particles 15. A liquid that has high electrical resistance and high transparency may be used for the dispersion medium 16, including, for example, an aromatic hydrocarbon solvent such as benzene, toluene, xylene, or the like, an aliphatic hydrocarbon solvent such as hexane, cyclohexane, or the like, and an insulating organic solvent such as polysiloxane, high purity petroleum, or the like. Note that in the electrophoretic display medium 1, any one of the dispersion media described above may be used alone, and a mixture of at least two dispersion media may also be used. The dispersion medium 16 may also contain other constituents as necessary. The other constituents may be a dispersing agent, a charge controlling agent, a viscosity modifying agent, and the like. The dispersing agent is used to assist in the dispersion of the charged particles 15 and may be, for example, a surface active agent or the like. The charge controlling agent is used to modify the electrophoretic properties of the charged particles 15 in the dispersion medium 16 and may be, for example, an alcohol or the like. The viscosity modifying agent is used to prevent the charged particles 15 from settling out of the dispersion medium 16 and may be, for example, a polymer resin or the like.

The charged particles 15 are particles that form an image on the display surface by migrating to one of the first substrate 11 side and the second substrate 12 side in response to an electrical field that is applied to each pixel. The charged particles 15 include PMMA particles that contain titanium oxide and are used as white charged particles and PMMA particles that contain carbon black and are used as black charged particles. The charged particles 15 may also use, for example, an inorganic pigment such as titanium oxide, zinc oxide, or the like, carbon black, an azoic pigment, and an organic pigment such as a phthalocyanine pigment or the like. Furthermore, the charged particles 15 may also be, for example, polymer particles that are made from a polymer material that is created by a known method, such as a suspension polymerization method, a dispersion polymerization method, a seed polymerization method, or the like. The charged particles 15 may also be, for example, composite particles that combine an inorganic material and a polymer material. It is also obvious that any desired color may be imparted to the polymer particles, the composite particles, and the like by a pigment, a dye, or the like. Note that for the charged particles 15, any one of the types of charged particles described above may be used alone, and a mixture of at least two types of charged particles may also be used.

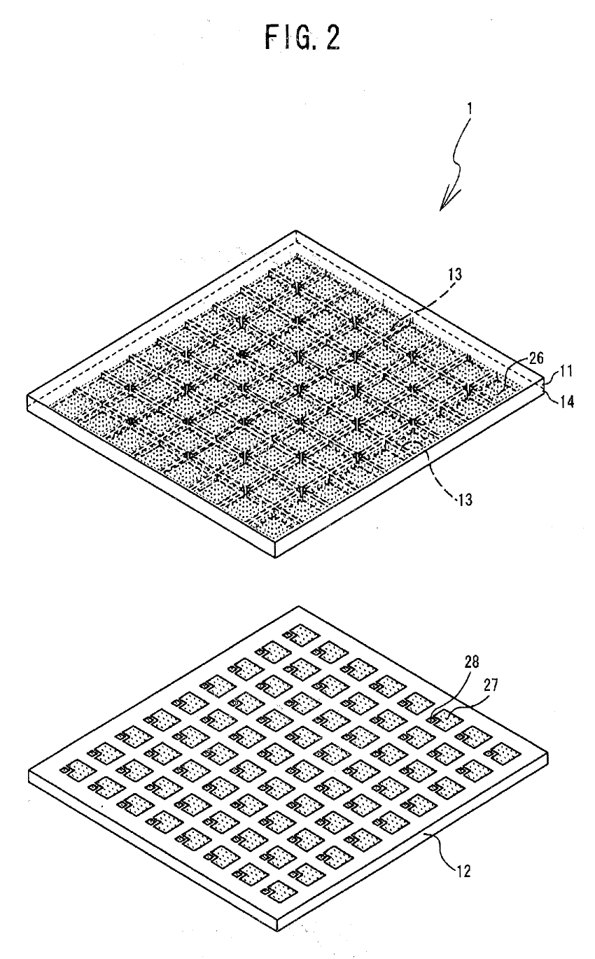

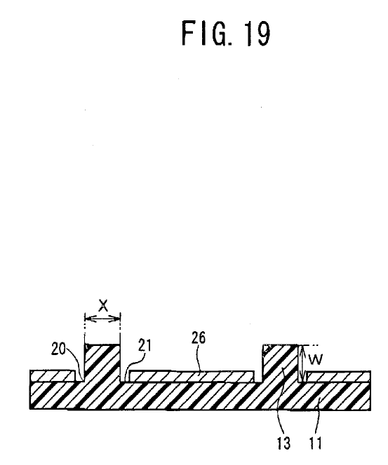

A configuration of the partition walls 13 will be explained with reference to FIGS. 2 to 4. As shown in FIG. 2, the partition walls 13 are formed as an integral part of the first substrate 11 and project toward the second substrate 12 from the inner face 20 of the first substrate 11. The partition walls 13 partition the space that is sandwiched between the first substrate 11 and the second substrate 12 into the plurality of the cells 17. As shown in FIG. 4, the partition walls 13 are one of cross-shaped and rod-shaped planar forms and are arranged in a regular manner on the inner face 20 of the first substrate 11 such that the partition walls 13 form a grid pattern overall. The thicknesses of the partition walls 13 (shown by the dimension X in FIGS. 4 and 19) may be 20 micrometers, for example. The lengths of the partition walls 13 (shown by the dimension Y in FIG. 4) may be 500 micrometers, for example. The rectangular partition walls 13 (each 20 micrometers by 500 micrometers) are formed such that pairs of them intersect at right angles at their midpoints to form cross-shaped planar forms. The partition walls 13 project 20 micrometers (shown by the dimension W in FIG. 19) toward the second substrate 12 from the inner face 20 of the first substrate 11. In the example described above, the height of the spacer 14 is 25 micrometers, so a gap of 5 micrometers exists between the second substrate 12 and the faces of the partition walls 13 that face the second substrate 12. The space that is sandwiched between the first substrate 11 and the second substrate 12 is partitioned into the plurality of the cells 17 by the partition walls 13 that are configured as described above. Each of the cells 17 is a roughly square planar form that measures 250 micrometers on a side. With this configuration, the areas within which the charged particles 15 can migrate are restricted to the interior portions of the cells 17. It is therefore possible to prevent disproportionate concentrations of the charged particles 15 in the dispersion medium 16 and to prevent display irregularities from occurring. Note that the partition wall 13 of the electrophoretic display medium 1 that is shown in FIG. 3 is not in contact with the second substrate 12, but it is acceptable for the partition walls 13 and the spacer 14 to be of the same height, such that the partition walls 13 and the second substrate 12 are in contact. The partition walls 13 and the spacer 14 may also be of the same thickness.

Consider a case of any one of the partition walls 13 among the plurality of the partition walls 13 that are shown in FIG. 4. In the present embodiment, a space that is demarcated by two of the partition walls 13 forms one of the cells 17. Each of the partition walls 13 is a cross-shaped planar form, and the intersection point of the cross shape is the center point of the partition wall 13. Within the plane shown in FIG. 4, four of the partition walls 13, each with its own center point, are arranged around the center point of any one of the partition walls 13, at 45-degree angles to the upper right, the lower right, the upper left, and the lower left, respectively. The length of one side of any one of the cells 17 is 250 micrometers, and each of the partition walls 13 has a thickness of 20 micrometers. In this case, the center points of any two diagonally adjacent partition walls 13 are separated by a distance that is equal to the length of a diagonal of a square that measures 270 micrometers on a side, that is, a distance that is equal to 270 micrometers multiplied by the square root of 2 (shown by the dimension Z in FIG. 4). The connecting portions 32 are formed at two diagonally opposite corners of each of the cells 17, which are square planar forms. Each of the connecting portions 32 is surrounded by end portions of four partition walls 13. The partition walls 13 are not formed in the connecting portions 32. Note that in FIG. 4, in order to show the connecting portions 32 clearly, the partition walls 13 are shown as having different dimensions from those used in the example described above.

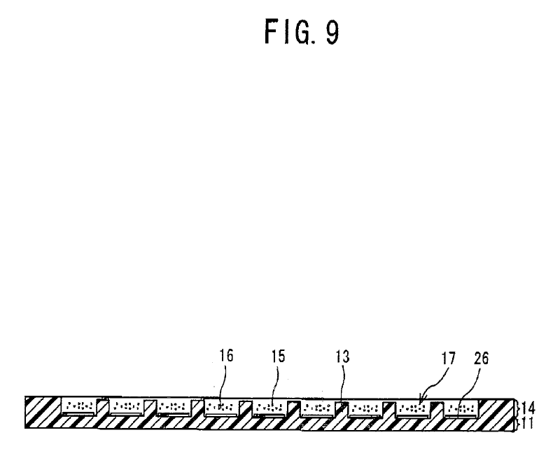

The partition walls 13 are not formed in the connecting portions 32. Therefore, in a case where the minimum distance between the end portions of adjacent partition walls 13 that form the connecting portions 32 is sufficiently larger than the mean particle size of the charged particles 15, an advantage is provided in that the electrophoretic display medium 1 can easily be filled uniformly with the charged particles 15 in a dispersion fluid injection process. Note that the dispersion fluid injection process will be described later with reference to FIG. 9. On the other hand, when the electrophoretic display medium 1 is used, the charged particles 15 may migrate among the cells 17 through the gaps in the connecting portions 32, allowing the charged particles 15 to cluster together. Generally, the charged particles 15 tend to migrate in the direction in which the user tilts the electrophoretic display medium 1 when using it, that is, in the direction of one of the longer side of the electrophoretic display medium 1 and the shorter side of the electrophoretic display medium 1.

In the electrophoretic display medium 1 according to the present embodiment, focusing on the connecting portions 32 that are arrayed parallel to the longer side, for example, the connecting portions 32 are arrayed such that the partition walls 13 are positioned between them. Specifically, the connecting portions 32 for which the minimum distance (the gap) between the end portions of the adjacent partition walls 13 that form the connecting portions 32 is not less than the mean particle size of the charged particles 15 are arrayed in the direction of the longer side (the direction indicated by an arrow 81) and the direction of the shorter side (the direction indicated by an arrow 82) of the electrophoretic display medium 1 such that the partition walls 13 are positioned between them. The mean particle size of the charged particles 15, which is to say, the mean volumetric particle size, can be determined, for example, by a Microtrac 3100 (manufactured by Nikkiso Co., Ltd.) that utilizes a laser diffraction scattering method (a Microtrac method). Because the partition walls 13 in this configuration are positioned between the connecting portions 32 that are adjacent in the direction of the longer side and the direction of the shorter side of the electrophoretic display medium 1, the linear movement of the charged particles 15 is restricted in both the direction of the longer side and the direction of the shorter side. Furthermore, for example, the distance on the plane between the connecting portions 32 that are arrayed diagonally at a 45-degree angle in relation to the longer side of the electrophoretic display medium 1 is shorter than the distance on the plane between the connecting portions 32 that are arrayed in the direction of the longer side of the electrophoretic display medium 1. The configuration is the same with respect to the direction of the shorter side of the electrophoretic display medium 1. Even if the minimum distance (the gap) between the end portions of the adjacent partition walls 13 that form the connecting portions 32 is not less than the mean particle size of the charged particles 15, in a case where the charged particles 15 move through the connecting portions 32 between at least two of the cells 17 that are arrayed in the direction of one of the longer side and the shorter side of the electrophoretic display medium 1, the charged particles 15 must move once in a diagonal direction. Therefore, in the electrophoretic display medium 1 according to the present embodiment, the charged particles 15 are less likely to move in the direction of the longer side and the direction of the shorter side of the electrophoretic display medium 1 than in a case where the connecting portions 32 are not arrayed with the partition walls 13 between them. It is therefore possible to reduce the display irregularities that are caused by the movement of the charged particles 15 between the cells 17. Note that the directions that correspond to the specified directions in which the connecting portions 32 are arrayed with the partition walls 13 positioned between them in the present disclosure can be freely determined according to the shape and the use of the electrophoretic display medium 1, the form in which the user uses the electrophoretic display medium 1, and the like. Therefore, the specified directions in the present disclosure, as in the example described above, may be the direction of the longer side and the direction of the shorter side of the electrophoretic display medium 1. Moreover, in a case where the electrophoretic display medium 1 is used such that it is tilted diagonally, for example, the connecting portions 32 may be arrayed such that the movement of the charged particles 15 in the diagonal direction is restricted. In this sort of arrangement, it is conceivable that the direction in which the partition walls 13 are arrayed would also be tilted 45 degrees in relation to the planar view. Furthermore, in addition to the case described above in which the connecting portions 32 are arrayed with the partition walls 13 between them, an arrangement may be used in which the adjacent partition walls 13 that surround the connecting portions 32 are arrayed such that the minimum distance between them is less than the mean particle size of the charged particles 15.

Forming the partition walls 13 as an integral part of the first substrate 11, as explained above, provides advantages, which are described below, over a known electrophoretic display medium in which partition walls are formed separately from a first substrate and from a different material than the first substrate. First, in the known electrophoretic display medium, the partition walls and the first substrate have different thermal expansion coefficients, such that when the temperature environment around the electrophoretic display medium changes, the partition walls may separate from the first substrate in the areas where the partition walls and the first substrate are connected. In contrast, in the electrophoretic display medium 1 according to the present embodiment, the partition walls 13 are formed as an integral part of the first substrate 11, so there is no concern that the partition walls 13 will separate from the first substrate 11 due to temperature changes. The electrophoretic display medium 1 can therefore be used with good results even in an environment where the temperature environment tends to vary.

Furthermore, because the partition walls 13 are formed as an integral part of the first substrate 11 in the electrophoretic display medium 1 according to the present embodiment, the partition walls 13 are less likely to separate from the first substrate 11 than in the known electrophoretic display medium, even when the electrophoretic display medium 1 is bent while in use. The electrophoretic display medium 1 can therefore be used with good results as a flexible electrophoretic display medium of the sort that has been proposed in recent years. Note that the thickness, the height, the shape, the spacing, and the like of the partition walls 13 can be modified as necessary to suit the material, the use, and the like of the electrophoretic display medium 1 and are not limited to the dimensions described above.

Next, various configuring elements of the electrophoretic display medium 1 will be described in detail with reference to FIGS. 1 to 3. A common electrode 26 that is provided on the first substrate 11 and a plurality of drive electrodes 27 that are provided on the second substrate 12 apply electrical fields to the electrophoretic display medium 1. The driving electrodes 27 are preferably covered by protective films (not shown in the drawings) that use a coating agent or the like that contains a fluorine compound.

The common electrode 26 that is provided on the first substrate 11 is made from an optically transparent, electrically conductive thin film that is made of indium tin oxide (ITO), zinc oxide that is doped with a metal, an electrically conductive polymer such as pentacene or the like, or the like. The common electrode 26 is comprised of electrode films 56 and electrode films 57. In each of the electrode films 56, an electrical field is generated that is applied to the charged particles 15, which have negative polarity. The electrode films 57 electrically connect the electrode films 56 that are adjacent to one another. The electrode films 56 are provided in the cell portions 31, and the electrode films 57 are provided in the connecting portions 32. The electrode films 56 are surrounded by the partition walls 13 and are positioned within each of the cells 17, which have square planar forms measuring 250 micrometers on a side, such that a margin of 1 micrometer is provided around the perimeter of each of the electrode films 56, thus giving each of the electrode films 56 a square planar form measuring 248 micrometers on a side. Each of the electrode films 57 is positioned with a margin of 1 micrometer between it and the surrounding partition walls 13 and plays a role of electrically connecting the electrode films 56 in the adjacent cell portions 31. The common electrode 26 is therefore a single, electrically connected electrode film that can electrically connect the electrode films 56 that are provided in the individual cells 17 without any complicated wiring being installed. Because the common electrode 26 is provided on the inner face 20 of the first substrate 11, the distance between the common electrode 26 and the drive electrodes 27 that are positioned on the second substrate 12 can be made shorter. Therefore, the electrophoretic display medium 1 that is manufactured by a manufacturing method according to the present disclosure is capable of using a voltage for application to the electrodes that is lower than the voltage that is used in a case where the common electrode 26 that is provided on the first substrate 11 is provided on the opposite side of the first substrate 11 from the inner face 20.

The drive electrodes 27 are arranged in the form of a matrix on the face of the second substrate 12 that faces the first substrate 11. The drive electrodes 27 are made from one of an optically transparent, electrically conductive thin film and a thin film that is made of an electrically conductive material that is not optically transparent, such as gold, silver, or the like. The optically transparent, electrically conductive thin film may be made of indium tin oxide (ITO), zinc oxide to which a metal is added, an electrically conductive polymer such as pentacene or the like, or the like. A thin film transistor 28 (refer to FIG. 2) that functions as a switch element is provided on an edge of each of the drive electrodes 27. Drive circuits (not shown in the drawings) that control each of the drive electrodes 27 apply selection signals to each row of the matrix of the drive electrodes 27. In addition, a control signal is applied to each column of the matrix of the drive electrodes 27, as is an output voltage from each of the thin film transistors 28 in each column, making it possible to apply a desired electrical field to the charged particles 15 and the dispersion medium 16 in the individual cells 17. Note that there is no limit on the number of the drive electrodes 27 that correspond to a single pixel. The drive electrodes 27 are not limited to having a planar form and can have any shape, such as a square shape, a rectangular shape, a circular shape, and the like.

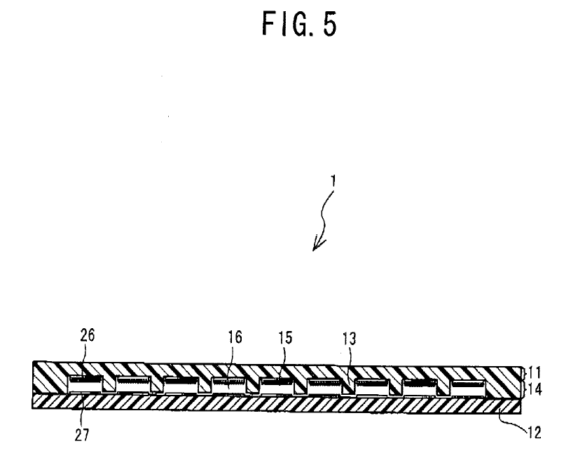

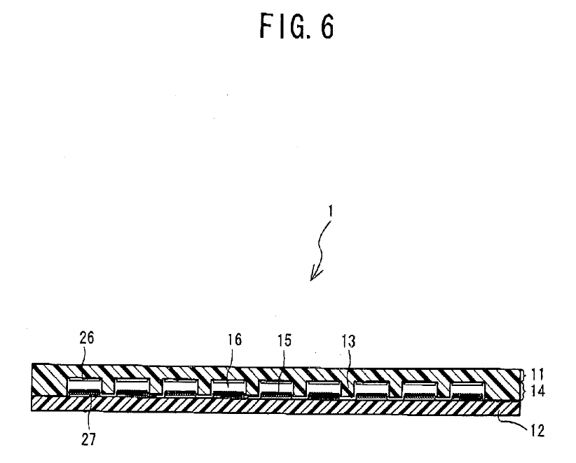

Next, a display switching operation in the electrophoretic display medium 1 will be explained with reference to FIGS. 5 and 6. In order to simplify the explanation, a case will be explained in which the dispersion medium 16 is colored white and the charged particles 15 are black particles that are negatively charged PMMA particles that contain carbon black. In order to explain the display switching operation in the electrophoretic display medium 1 schematically, the configuring elements that are shown in FIGS. 5 and 6 are shown with different dimensions than the corresponding configuring elements in the section view that is shown in FIG. 3.

In FIG. 5, a voltage of zero volts is applied to the common electrode 26 that is provided on the first substrate 11, and a voltage of −50 volts is applied to all of the drive electrodes 27 that are provided on the second substrate 12, such that the charged particles 15, which have negative charges, move toward the first substrate 11. This causes the black charged particles 15 to adhere to the first substrate 11, such that a black color is displayed on the display surface of the first substrate 11.

Note that the voltages are applied to both the common electrode 26 and the drive electrodes 27 in order to move the charged particles 15, but even if the voltages are temporarily cut off, such that the voltages on the electrodes 26, 27 both become zero volts, the state of adhesion of the charged particles 15 to the first substrate 11 is maintained.

In FIG. 6, the charged particles 15, which have negative charges, are moved toward the second substrate 12 by applying a voltage of zero volts to the common electrode 26 and a voltage of 50 volts to the drive electrodes 27. This causes the black charged particles 15 to adhere to the second substrate 12. Thus only the white dispersion medium 16 is left on the side of the first substrate 11, so a white color is displayed over the entire display surface of the first substrate 11. Note that the voltages that are applied to each electrode can be varied in any number of ways according to the distance between the electrodes, the charge of the charged particles 15, and the like.

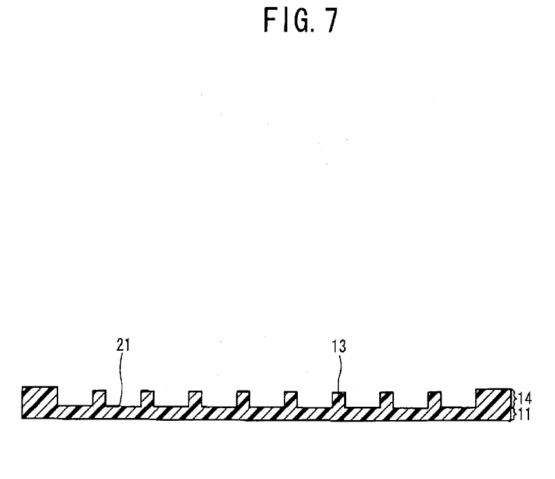

Next, a first embodiment that is an example of the manufacturing method for the electrophoretic display medium 1 according to the present embodiment will be explained with reference to FIGS. 7 to 10. Note that in order to explain each process schematically, the configuring elements that are shown in FIGS. 7 to 10 are shown with different dimensions than the corresponding configuring elements in the section view that is shown in FIG. 3.

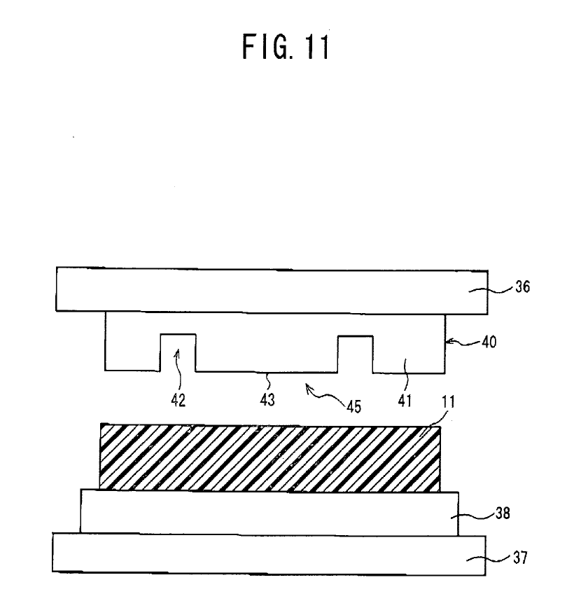

First, as shown in FIG. 7, the partition walls 13 and the spacer 14 are formed as a single unit with the first substrate 11 in a partition wall formation process. The partition wall formation process will be explained in detail later with reference to FIGS. 11 to 14. Note that in the first embodiment, the spacer 14 is formed in the partition wall formation process as a single unit with the first substrate 11 and the partition walls 13, but the spacer 14 may also be formed in a separate process after the first substrate 11 and the partition walls 13 are formed. In a case where the spacer 14 is formed in a separate process, the common electrode 26 may be formed after the spacer 14 is formed, and the spacer 14 may be formed after the common electrode 26 is formed.

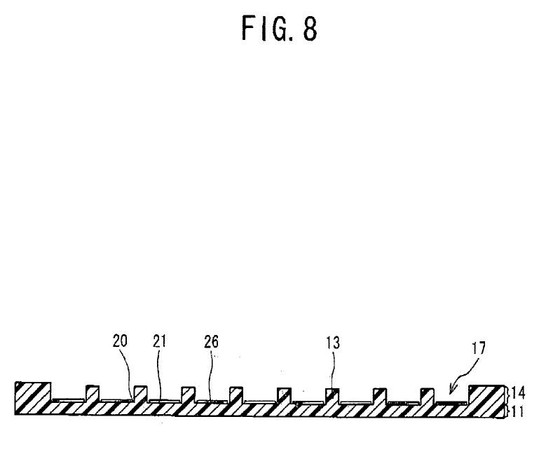

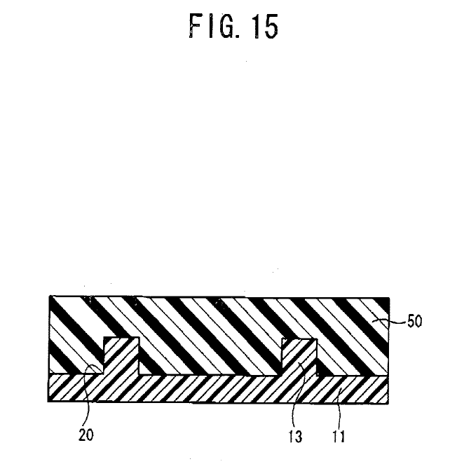

Next, as shown in FIG. 8, the common electrode 26 is formed on the inner face 20 of the first substrate 11 in an electrode film formation process. The electrode film formation process will be explained in detail later with reference to FIGS. 15 to 19.

Next, in a dispersion fluid injection process, as shown in FIG. 9, the dispersion fluid, which contains the charged particles 15 and the dispersion medium 16 that disperses the charged particles 15, is injected into the cells 17, which are a plurality of recessed portions that are demarcated by the partition walls 13.

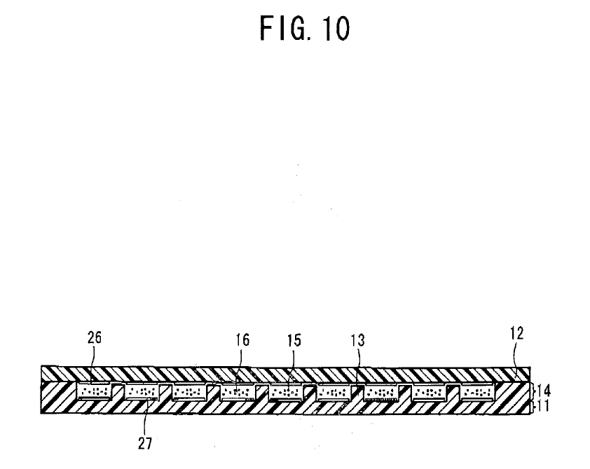

Next, as shown in FIG. 10, the second substrate 12 is attached to the first substrate 11 in a second substrate attachment process. The drive electrodes 27, the thin film transistors 28 (refer to FIG. 2), and the drive circuits (not shown in the drawings) that control the drive electrodes 27 are formed in advance on the face of the second substrate 12 that faces the first substrate 11. The drive electrodes 27, the thin film transistors 28 (refer to FIG. 2), and the drive circuits (not shown in the drawings) that control the drive electrodes 27 are formed by a known technology, such as a photolithography method or the like, for example. Note that FIG. 10 shows a case in which a resin material is used as the material of the second substrate 12, but as described above, a transparent material such as glass or the like, for example, and an opaque material may also be used. For example, the second substrate 12 may be formed using a material that is not transparent, such as stainless steel, aluminum, or the like, and that is provided with an insulating layer on its surface.

The electrophoretic display medium 1 is manufactured by the processes that are explained above. Next, the partition wall formation process will be explained in detail with reference to FIGS. 11 to 14. Note that the number of the partition walls 13 that are formed in the partition wall formation process shown in FIG. 7 is eight, but FIGS. 11, 13, and 14 show enlarged views of a portion of the first substrate 11 on which two of the partition walls 13 out of the eight partition walls 13 are formed. In order to explain the various processes schematically, in the same manner as in FIGS. 7 to 10, the configuring elements that are shown in FIGS. 11, 13, and 14 are shown with different dimensions than the corresponding configuring elements in the section view that is shown in FIG. 3.

In the first embodiment, the first substrate 11, the partition walls 13, and the spacer 14 are formed as a single unit using PET, which is a thermoplastic resin, as the synthetic resin. Further, the partition wall formation process according to the first embodiment includes a press forming process and a die release process. In the press forming process, a forming die 40 that has a forming surface 45 with recessed and protruding portions is pressed upon a synthetic resin that contains a thermoplastic resin, such that the unprocessed first substrate 11 is shaped by being made to conform to the recessed and protruding portions of the forming surface 45 of the forming die 40. In the die release process, the forming die 40 is removed from the first substrate 11 that contains the thermoplastic resin.

First, in the press forming process of the partition wall formation process according to the first embodiment, a press unit with an attached heating mechanism presses the forming die 40 upon the unprocessed first substrate 11 that contains the thermoplastic resin. The forming die 40 is provided with the forming surface 45 with the recessed and protruding portions that match the protrusions and recesses of the partition walls 13 and the spacer 14. Therefore, in the press forming process, the unprocessed first substrate 11 is shaped by being made to conform to the recessed and protruding portions of the forming surface 45 of the forming die 40.

The press unit with the attached heating mechanism is not an essential part of the present disclosure, so it is not shown in its entirety, but the press unit with the attached heating mechanism includes a support plate 36 and a support plate 37 that are positioned such that they face one another. The support plate 36 is placed in the press unit with the attached heating mechanism in such a position that it faces the support plate 37. The support plate 36 is also placed in a position that is above the support plate 37 in the vertical direction and such that it can be moved up and down in the vertical direction. The support plate 36 also includes a heater in its interior that serves as a heat source for heating the first substrate 11 to a specified temperature through the forming die 40. The forming die 40 is fixed to the bottom face of the support plate 36 such that the forming surface 45 is on the bottom side in the vertical direction. Note that the distance that the support plate 36 moves up and down can be set appropriately for the object to be pressed.

The support plate 37 is fixed in a specified position in the press unit with the attached heating mechanism such that its top face is horizontal. The support plate 37 also includes a heater in its interior that serves as a heat source for heating the first substrate 11 to a specified temperature. A substrate holding plate 38 is fixed to the top face of the support plate 37 such that a press face of the substrate holding plate 38 is on the top side in the vertical direction. The forming die 40 and the substrate holding plate 38 are respectively fixed to the support plate 36 and the support plate 37 such that they can be removed.

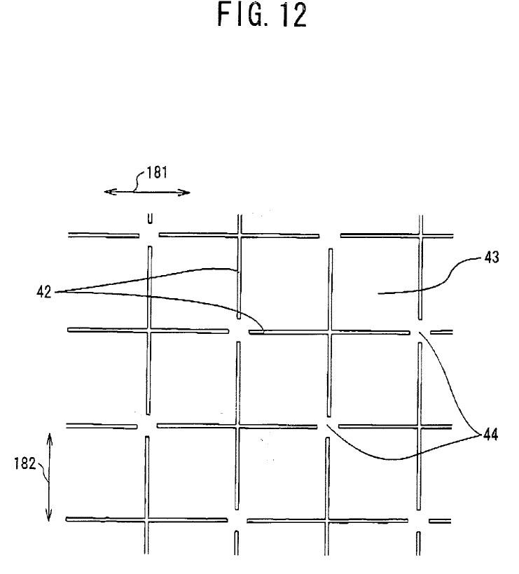

As shown in FIG. 12, a plurality of recessed portions 42 are formed in specified positions on a flat surface of the forming surface 45, which is the face of the forming die 40 that faces the substrate holding plate 38. The recessed portions 42 are portions that correspond to the partition walls 13 and the spacer 14. The shape of the recessed portions 42 that correspond to the partition walls 13 may be, for example, a cross shape in which two three-dimensional rectangular forms measuring 20 micrometers by 500 micrometers in a planar view, and with a depth of 20 micrometers, are formed such that they intersect at right angles at their respective midpoints. The recessed portions 42 that correspond to the spacer 14 are not shown in FIG. 12, but they are 25 micrometers deep and are formed around an outer edge portion of the first substrate 11. Marks that are used for positioning in an electrically conductive film formation process that is described later are also provided in at least two diagonally opposite locations among the four corners of the spacer 14.

Projecting faces of protruding portions 41 of the forming die 40 correspond to the non-wall portions 21, which are the portions of the inner face 20 of the first substrate 11 where the partition walls 13 are not formed. The projecting faces of the protruding portions 41 may have, for example, square planar forms that measure 250 micrometers on a side and are framed by two of the cross-shaped recessed portions 42. As shown in FIGS. 11 and 12, cell corresponding portions 43 are raised surfaces that correspond to the cell portions 31. The cell corresponding portions 43 that are adjacent to one another are connected and made continuous by linking portions 44. The linking portions 44 are raised surfaces that correspond to the connecting portions 32. The non-wall portions 21 of the first substrate 11 correspond to the cell corresponding portions 43 and the linking portions 44 of the forming die 40. Therefore, the non-wall portions 21 of the first substrate 11 that is formed using the forming die 40 are also continuous. Accordingly, the common electrode 26, which is made of a continuous electrode film, can be formed by forming an electrode film on the surface of the continuous non-wall portions 21 that are formed using the forming die 40. This makes it possible to ensure an electrical connection with the common electrode 26 without installing any complicated wiring.

The minimum distance between the neighboring recessed portions 42 that surround each of the linking portions 44 is called a distance between the recessed portions. In the example described above, the distance between the recessed portions is equal to the length of a diagonal of a square, the lengths of whose sides is expressed as 250 micrometers−(500 micrometers−20 micrometers)/2. That is, the distance between the recessed portions is equal to 10 micrometers multiplied by the square root of 2. The linking portions 44 that ensure the continuity (the electrical connectedness) of the common electrode 26 in the electrophoretic display medium 1 that is manufactured by the method in the first embodiment are arrayed in the direction indicated by an arrow 181 and in the direction indicated by an arrow 182 such that the recessed portions 42 that form the partition walls 13 are positioned between the linking portions 44. Thus, even in a case where charged particles are used whose mean particle size is not greater than the distance between the recessed portions, this configuration makes it possible for the movement of the charged particles 15, in the indicated directions through the locations (the connecting portions 32) that correspond to the linking portions 44, to be restricted by the partition walls 13 that are formed as an integral part of the first substrate 11 using the forming die 40. It is therefore possible to reduce the display irregularities that are caused by the movement of the charged particles 15 between the cells 17. Note that the direction indicated by the arrow 181 corresponds to the direction of the longer side of the electrophoretic display medium 1 that is indicated by the arrow 81 in FIG. 4. The direction indicated by the arrow 182 corresponds to the direction of the shorter side of the electrophoretic display medium 1 that is indicated by the arrow 82.

Note that the specified directions in which the movement of the charged particles 15 is restricted in the present disclosure can be freely determined according to the shape and the use of the electrophoretic display medium 1 that is manufactured as described above, the form in which the user uses the electrophoretic display medium 1, and the like. Therefore, the specified directions in the present disclosure, as in the example described above, may be the direction of the longer side and the direction of the shorter side of the electrophoretic display medium 1. Moreover, in a case where the electrophoretic display medium 1 is manufactured such that it is tilted diagonally when it is used, for example, the linking portions 44 may be arrayed such that the movement of the charged particles 15 in the diagonal direction is restricted. Note that in FIG. 12, in order to show the linking portions 44 clearly, the recessed portions 42 are shown as having different dimensions from those used in the example described above.

The press face of the substrate holding plate 38 is a flat surface. The first substrate 11 is placed on the flat surface of the substrate holding plate 38 and positioned such that the center of the first substrate 11 is opposite the center of the substrate holding plate 38. At this time, the first substrate 11 is placed such that the inner face 20 is on the top side in the vertical direction. Note that in a case where a portion of the first substrate 11 is made of a synthetic resin, the first substrate 11 is placed on the substrate holding plate 38 such that the face that includes the synthetic resin is the top face. Next, the forming surface 45 of the forming die 40 is brought into contact with the first substrate 11.

Next, the first substrate 11 is heated by a heater that is built into the press unit with the attached heating mechanism. The heat that is generated by the heater is transmitted to the first substrate 11 through the forming die 40 and the substrate holding plate 38, and the first substrate 11 is heated to 140° C., for example. The heating temperature is set to a temperature that is 10° C. to 70° C. higher than the glass transition temperature (Tg) of a thermoplastic resin. PET is the thermoplastic resin that is used in the first embodiment, and the temperature at which it softens is in the range of 80° C. to 90° C., so when the first substrate 11 that is formed from PET is heated to 140° C., it softens and becomes easy to use for plastic forming.

Next, the forming die 40 is pressed upon the first substrate 11 and maintained in the heated and pressurized state for a fixed period of time. In the first embodiment, a state in which a pressure of 5 MPa is applied is maintained for 5 minutes. This process causes a portion of the first substrate 11, which is made of softened PET, to protrude into the recessed portions 42 of the forming die 40, such that projecting portions of the same shape as the recessed portions 42 are formed on the inner face 20 of the first substrate 11. Note that the projecting portions that protrude into the recessed portions 42 become the partition walls 13 and the spacer 14 in the electrophoretic display medium 1 described above. Portions of the first substrate 11 that correspond to the protruding portions 41 of the forming die 40 become the non-wall portions 21 of the first substrate 11 of the electrophoretic display medium 1 described above. Next, the set temperature of the heater that is built into the press unit with the attached heating mechanism is set to 60° C., for example, and the first substrate 11 is left in the press unit for a fixed period of time. When the first substrate 11 has been cooled to approximately 60° C., the softened thermoplastic resin of the first substrate 11 will have become harder than it was during the press forming process. This process makes it easier to separate the forming die 40 from the first substrate 11.

Next, in the die release process, the forming die 40 is separated from the first substrate 11. The partition walls 13 and the spacer 14 have been formed as integral parts of the first substrate 11 from which the forming die 40 has been separated. The marks that are used for positioning in the electrically conductive film formation process that is described later have also been formed. Note that in the first embodiment, the first substrate 11 is cooled in the press forming process, but the cooling may be omitted by stopping the heating in a specific temperature range.

The partition walls 13 that are formed by the partition wall formation process that is described in detail above are formed as a single unit with the first substrate 11, as described above, so there is no concern that the partition walls 13 will separate from the first substrate 11. Therefore, the display irregularities that occur due to the separating of the partition walls 13 from the first substrate 11 can be more reliably avoided. Because the partition walls 13 are formed as a single unit with the first substrate 11 before the common electrode 26 is formed on the inner face 20 of the first substrate 11, there is no need to consider the heat resistance of the common electrode 26 in the partition wall formation process. It is therefore possible to set the heating temperature higher than in a case where the partition walls 13 are formed on the first substrate 11 after the common electrode 26 is formed. It is also possible to avoid situations in which the electrode film adheres to the faces of the partition walls 13 that face the second substrate 12, to the side faces of the partition walls 13, and to the forming die 40.

Next, the electrode film is formed in the non-wall portions 21 of the first substrate 11 that were formed in the die release process. The electrode film formation process will be explained in detail with reference to FIGS. 15 to 19. Note that in the same manner as in the partition wall formation process described above, the number of the partition walls 13 is eight in the electrode film formation process shown in FIG. 8, but FIGS. 15 to 19 show enlarged views of a portion of the first substrate 11 on which two of the partition walls 13 out of the eight partition walls 13 are formed. In order to explain the various processes schematically, in the same manner as in FIGS. 7 to 10, the configuring elements that are shown in FIGS. 15 to 19 are shown with different dimensions than the corresponding configuring elements in the section view that is shown in FIG. 3.

In the first embodiment, first, in a resist film formation process, a lithographic exposure process, and a development process, processing is performed that causes resist films 52 to cover outer edge portions of the parts of the first substrate 11 other than the non-wall portions 21, that is, the partition walls 13 and the spacer 14. This processing is performed so that the electrode film will not be formed in locations other than the non-wall portions 21 of the first substrate 11. The outer edge portions of the partition walls 13 are the faces of the partition walls 13 that face the second substrate 12, as well as the side faces of the partition walls 13.

Next, in the electrode film formation process, the common electrode 26 and electrode films 53 are formed. Then in a lift-off process, the resist films 52 that covered the outer edge portions of the partition walls 13 and the spacer 14 are removed, as are the electrode films 53 that were formed on top of the resist films 52. Note that in a case where the spacer 14 is formed as a separate piece from the first substrate 11 and the partition walls 13 and is formed after the common electrode 26 is formed in the non-wall portions 21 of the first substrate 11, the resist films may be formed such that they cover only the outer edge portions of the partition walls 13. The various processes in the electrode film formation process will be described in detail below.

First, in the resist film formation process, as shown in FIG. 15, a resist film 50 is formed that has sufficient thickness to cover the partition walls 13 and the spacer 14 on the inner face 20 of the first substrate 11. The purpose of the resist film 50 is to form a masking resist film on the outer edge portions of the partition walls 13 and the spacer 14 in order to prevent the electrode film that makes up the common electrode 26 from adhering to the outer edge portions of the partition walls 13 and the spacer 14. The resist that forms the resist film 50 may be a positive type resist and may be a negative type resist. However, taking into consideration the simplicity of the processing that removes, in the lift-off process, which is described later, the resist films 52 that are formed on the outer edge portions of the partition walls 13 and the spacer 14, it is preferable to use the positive type resist. In the first embodiment, the resist film 50 is formed using a positive type resist whose base is one of an acrylic resin and a novolac resin.

The resist that is used to form the resist film 50 may be a coating type resist and may also be a film type resist. In a case where the coating type resist is used, the resist film 50 may be formed on the first substrate 11 by rolling the resist onto the first substrate 11, for example, after which a baking process is performed for two minutes at 90° C., for example. In contrast, in a case where the film type resist is used, the resist film 50 is formed by using a laminator to apply the film type resist to the inner face 20 of the first substrate 11. In this case, the desired resist film 50, which has an appropriate degree of adhesion and no air trapped under it, is produced by regulating an application pressure, a roller temperature, and a roller revolution speed.

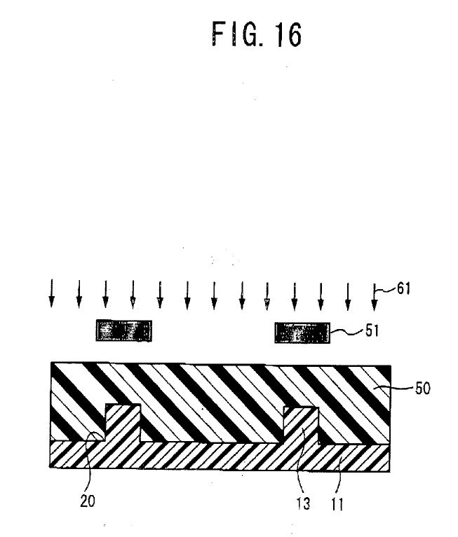

Next, in the lithographic exposure process, as shown in FIG. 16, the resist film 50 is irradiated with ultraviolet light in the direction indicated by arrows 61 through a mask 51 that covers the tops of the outer edge portions of the partition walls 13 and the spacer 14 that are formed on the inner face 20 of the first substrate 11. The positioning of the mask 51 is performed using the positioning marks that were formed in the partition wall formation process and are provided in the at least two diagonally opposite locations among the four corners of the spacer 14. This makes it easy to perform the positioning of the mask using the positioning marks and to cover the outer edge portions of the partition walls 13 and the spacer 14 reliably.

The lithographic exposure conditions are determined according to the photosensitive wavelength of the resist, so the resist is irradiated for a specified period of time with light that has a wavelength of 365 nanometers (i-line), for example. This processing makes the resist film 50 soluble in a developing fluid, except in the outer edge portions of the partition walls 13 and the spacer 14. Note that FIG. 16 shows a case in which the resist film 50 is made of a positive type resist, but in a case where the resist film 50 is made of a negative type resist, it is the areas of the resist film 50 that cover the outer edge portions of the partition walls 13 and the spacer 14 that are irradiated with light.

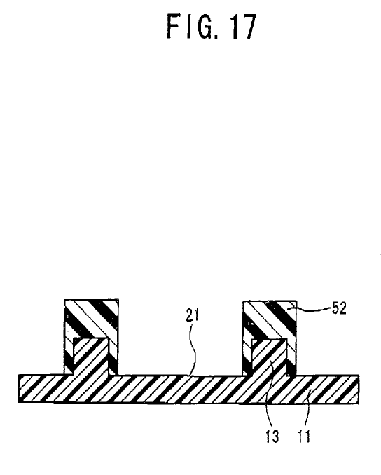

Next, in the development process, processing is performed that uses the developing fluid to dissolve the resist film 50 in the areas that were exposed to the light in the lithographic exposure process, that is, the areas other than the outer edge portions of the partition walls 13 and the spacer 14. The developing fluid that is used in this process may be an organic alkaline solution such as 2.38% (by weight) tetramethylammonium hydride (TAMH) or the like, and may also be an inorganic alkaline solution such as sodium carbonate or the like. The developing method may be puddle processing that performs the developing using a puddle of the developing fluid that is formed on the surface of the resist, which is placed in a horizontal orientation, dip processing that performs the developing by immersing the resist in the developing fluid, spray processing that performs the developing by spraying the developing fluid onto the resist, or the like. In the first embodiment, puddle processing that uses 2.38% (by weight) TAMH as the developing fluid is performed for one minute, after which the first substrate 11 is washed with pure water for three minutes. As shown in FIG. 17, this processing forms the resist films 52 that cover the outer edge portions of the partition walls 13, which include the side faces and the top faces of the partition walls 13. Although they are not shown in the drawings, the resist films 52 also cover, in the same manner, the outer edge portions of the spacer 14, which include the side faces and the top faces of the spacer 14. Note that in a case where a negative type resist is used for the resist film 50, the processing in the development process by which the resist is dissolved by the developing fluid is performed on the areas other than the areas that were exposed to the light in the lithographic exposure process.

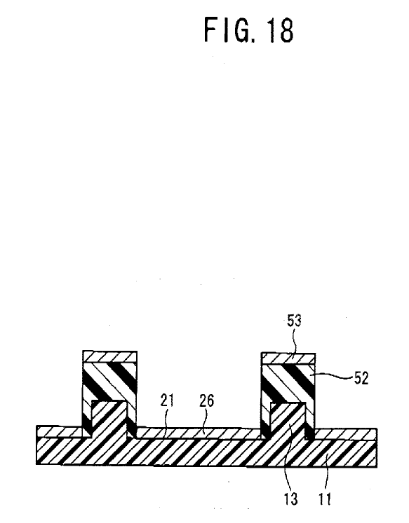

Next, in the electrode film formation process, as shown in FIG. 18, the common electrode 26 and the electrode films 53, which are both made of a transparent electrode film, are respectively formed in the non-wall portions 21 of the first substrate 11, where the resist film was removed in the development process, and on the surfaces of the resist films 52, which remain on the outer edge portions of the partition walls 13 after the development process. As stated previously, the material that is used for the electrode film is an optically transparent, electrically conductive material such as ITO or the like. The method by which the electrode film is formed may be a spattering method, a vacuum disposition method, an ion plating method, a wet plating method, a coating method, or the like. The spattering method is a method in which the electrode film material is bombarded with argon gas particles, such that target constituents are dislodged by the impact in such a way that they form a thin film of the electrode film material on the first substrate 11, which is placed in close proximity to the electrode film material. The vacuum disposition method is a method that heats, melts, and vaporizes the electrode film material in a vacuum and causes the electrode film material to adhere to the first substrate 11. The ion plating method is a method that uses a gas plasma to energize some of the particles in a vapor into becoming ions or excited particles that are deposited on the first substrate 11. The wet plating method is a method in which the first substrate 11 is immersed in a plating solution, and the coating method is a method in which the first substrate 11 is coated with the electrode film material. In the first embodiment, corona processing is performed in which a spattering method that uses the ITO target material and an argon spatter gas causes high energy to act on an electrode, creating a corona discharge that forms the electrode film on the inner face 20 of the first substrate 11. The energy in this process may be, for example, not greater than 100 watt-minutes per meter.

Next, in the lift-off process, the resist films 52 on the outer edge portions of the partition walls 13 and the spacer 14, which remain after the entire surface of the inner face 20 of the first substrate 11 has been exposed to light from an oblique direction and the development process has been performed, have been put into a soluble state by the developing fluid. Note that because the films will be lifted off are transparent films, the light exposure may also be performed from a vertical direction. Next, all of the resist films 52 are dissolved using the developing fluid that was used in the development process described above, after which rinsing is performed. The reaction time for the development processing is longer than is used the development process described above, three to ten minutes, for example, at the end of which time the resist films 52 have been completely removed. As shown in FIG. 19, this processing completely removes the masking resist films 52 that adhered to the outer edge portions of the partition walls 13 and the spacer 14 and also completely removes the electrode films 53 that adhered to the resist films 52, thus forming the common electrode 26. Note that in a case where the resist films 52 are made from a negative type resist, bridges develop in the parts that are exposed to the light in the lithographic exposure process, making the resist films 52 insoluble in the developing fluid, so the resist films 52 are removed using a solvent with greater dissolving power, such as N-methyl-2-pyrrolidone (NMP). In a case where the resist films 52 have hardened to such an extent that they cannot be removed even by this sort of solvent, processing is performed that removes the resist films 52 by coercive processing such as ashing, polishing, or the like.

The various processes of the electrode film formation process shown in FIGS. 15 to 19 and explained above form the common electrode 26, which is an electrode film with a planar shape that connects the non-wall portions 21 of the first substrate 11. Thus, in the first embodiment, because the outer edge portions of the partition walls 13 and the spacer 14 are masked by the resist films 52, it is possible to avoid ill effects on the display due to the adhesion of the electrode film to those portions.

According to the manufacturing method for the electrophoretic display medium 1 that is described in detail above, the first substrate 11 and the partition walls 13 are formed as a single unit from a synthetic resin, so the partition walls 13 do not readily separate from the first substrate 11. It is therefore possible to manufacture the electrophoretic display medium 1 such that impairment of the display function due to the separating of the partition walls 13 from the first substrate 11 is prevented. Because the common electrode 26 that is positioned on the first substrate 11 is provided on the inner face 20 of the first substrate 11, the distance between the common electrode 26 and the drive electrodes 27 that are positioned on the second substrate 12 can be made shorter. Therefore, the voltage that is applied to the common electrode 26 that is positioned on the first substrate 11 can be kept lower than in a case where the electrode is provided on the opposite face from the inner face of the first substrate. The first substrate 11 is made from a thermoplastic resin, and in the press forming process, the thermoplastic resin is heated and softened as it is pressed. It is therefore easy to form the partition walls 13 on the first substrate 11, because the conditions of temperature for softening the synthetic resin are easily controlled.

After the outer edge portions of the partition walls 13, where the common electrode 26 is not formed, are covered by the resist films 52, the common electrode 26, which is formed from the electrode films 56 and the electrode films 57, is formed, as are the electrode films 53. Next, the resist films 52 and the electrode films 53 that are formed on top of the resist films 52 are removed. Therefore, the common electrode 26 can be formed in the desired position on the first substrate 11, and the formation of electrode films on the faces of the partition walls 13 that face the second substrate 12, as well as on the side faces of the partition walls 13, can be reliably avoided. Because the common electrode 26 is formed from a transparent electrode, the first substrate 11 can serve as a display surface.

The cell corresponding portions 43 of the forming die 40, which correspond to the cell portions 31 of the first substrate 11, are connected and made continuous through the linking portions 44. Accordingly, the non-wall portions 21, which include the cell portions 31 and the connecting portions 32 of the first substrate 11 that are formed using the forming die 40, are also continuous. It is therefore possible to form the continuous common electrode 26 on the inner face 20 of the first substrate 11 without performing any processing to electrically connect individual electrode films. The linking portions 44, which correspond to the connecting portions 32 that ensure the continuity (the electrical connectedness) of the common electrode 26, are arrayed in the direction indicated by the arrow 181 and in the direction indicated by the arrow 182 such that the recessed portions 42 that correspond to the partition walls 13 are positioned between the linking portions 44. This configuration restricts the movement of the charged particles 15 between the cells 17 in the indicated directions through the connecting portions 32 that correspond to the linking portions 44. Therefore, even in a case where the linking portions 44 are provided that correspond to the connecting portions 32 that ensure the electrical connections between the electrode films 56 that are provided in the cell portions 31, it is possible to avoid the display irregularities that occur due to the movement of the charged particles 15 between the cells 17.

Note that the electrophoretic display medium, the electrophoretic display medium manufacturing method, and the electrophoretic display device according to the present disclosure are not limited by the present embodiment described above, and various modifications may be made insofar as they are within the scope of the present disclosure. The present embodiment has been explained as a compact display panel that is suitable for use in a portable electronic device, but the size of the electrophoretic display medium, the electrophoretic display device in which the electrophoretic display medium is used, and the like, are not limited by the present embodiment, and may be of many different types.

In the present embodiment, the first substrate 11 that is formed as a single unit with the partition walls 13 forms the display surface, but the second substrate 12 may also form the display surface. In that case, the second substrate 12 may be formed from one of a transparent and a semi-transparent material, and the first substrate 11, the partition walls 13, and the common electrode 26 may be formed using materials that are neither transparent nor semi-transparent. However, even in a case where the second substrate 12 forms the display surface, the partition walls 13 have an effect on the display, so it is desirable for the first substrate 11 and the partition walls 13 to be formed from a material with a low level of visibility.

In the present embodiment, the electrophoretic display medium 1 was explained using an example in which the charged particles 15 move within a liquid, but the present disclosure can also be applied to an electrophoretic display medium in which the charged particles 15 move within a gas. In that case, a gas that contains the charged particles 15 may be injected by a known method in the dispersion fluid injection process shown in FIG. 9.

In the present embodiment, the drive electrodes 27 were explained as corresponding one-to-one to the cells 17. However, a plurality of groups of the drive electrodes 27 may also be provided for each of the cells 17, and one group of the drive electrodes 27 may also correspond to a plurality of the cells 17. In the forming die 40 that is used in the partition wall formation process in the first embodiment, the cell corresponding portions 43 are made continuous by the linking portions 44, but the forming die 40 is not limited by this example. For example, in a case where the electrode films 56 that are provided in the cell portions 31 that correspond to the cell corresponding portions 43 are electrically connected by wiring or the like, it is acceptable for the cell corresponding portions 43 not to be joined by the linking portions 44. It is also acceptable for only a portion of the cell corresponding portions 43 to be joined. Further, in a case where the linking portions 44 are provided to ensure electrical connectedness between the electrode films 56, the arrangement of the linking portions 44 may be determined such that the cell corresponding portions 43 are made continuous by the linking portions 44.

The press forming process in the first embodiment described above is performed after the first substrate 11 has been heated. But the press forming process is not limited to this example, and various conditions can be determined for the press forming process according to the synthetic resin that is used. For example, a stimulus hardening resin may be used that is hardened by an external stimulus such as heat, light such as ultraviolet light or the like, oxygen, mixing (stirring), or the like. In a case where an ultraviolet light hardening resin is used as the stimulus hardening resin, in the press forming process, the ultraviolet light hardening resin is pressed in a forming die that is optically transparent and is then irradiated with ultraviolet light. This processing can be used provided that the unprocessed first substrate that contains the ultraviolet light hardening resin is formed such that it conforms to the recessed and protruding portions of the forming surface of the forming die. In this case, the hardening reaction can be easily regulated by regulating the irradiation conditions of the ultraviolet light that irradiates the ultraviolet light hardening resin. Furthermore, the resin only needs to fill the interior of the forming die, so a high pressing force is not required. A thermosetting resin that is hardened by heating may also be used as the stimulus hardening resin, for example. In this case, in the press forming process, the thermosetting resin is pressed in a forming die and heated, causing the thermosetting resin to be formed such that it conforms to the recessed and protruding portions of the forming surface of the forming die. The hardening reaction of the thermosetting resin can be easily regulated by regulating the heating conditions for the thermosetting resin. In a case where a hardening resin that is hardened by contact with oxygen is used as the stimulus hardening resin, for example, in the press forming process, the hardening resin is formed in such a way that it is exposed to an oxygen-bearing atmosphere. In a case where a hardening resin is used that hardens when a plurality of materials are mixed together, the hardening resin may be formed in the press forming process after the hardening resin materials are mixed. In these cases, the synthetic resin can be hardened without using a special device such as a heating unit, an ultraviolet light source, or the like.

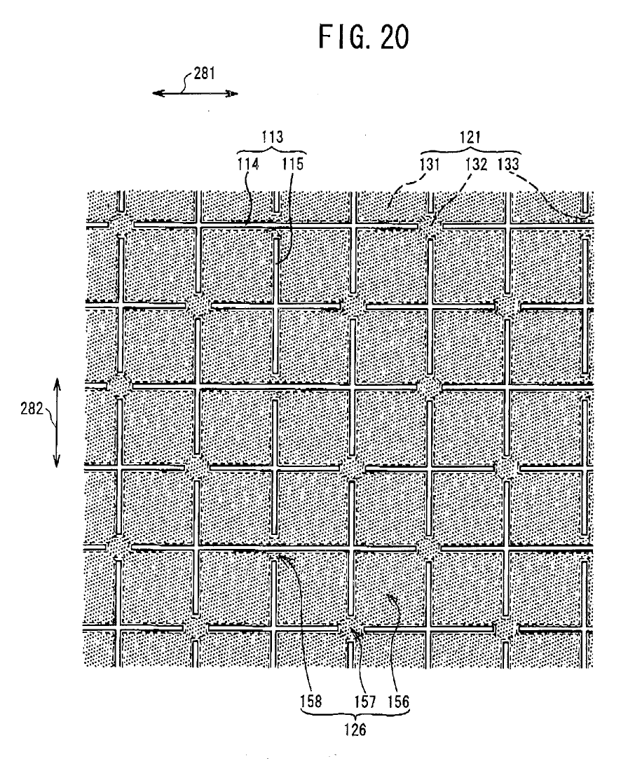

The shapes, sizes, numbers, and the like of the various configuring elements of the electrophoretic display medium 1 can be modified as one sees fit. For example, in the present embodiment, the partition walls 13 have a planar grid form, but they are not limited to this form, and various forms can be used to partition the space that is sandwiched between the first substrate and the second substrate. For example, the partition walls may be formed by a forming die that includes recessed portions that have flat shapes with outlines that are one of rectangular, circular, and elliptical. As examples of the shapes of the partition walls, first to third modified examples will be explained with reference to FIGS. 20 to 22.

First, the first modified example will be explained with reference to FIG. 20. In FIG. 20, the direction indicated by an arrow 281 is the direction of a longer side of an electrophoretic display medium according to the first modified example, and the direction indicated by an arrow 282 is the direction of a shorter side of the electrophoretic display medium according to the first modified example. As shown in FIG. 20, the electrophoretic display medium in the first modified example includes a common electrode 126 in non-wall portions 121 of a first substrate, in the same manner as the electrophoretic display medium 1 described above. The non-wall portions 121 include cell portions 131, as well as connecting portions 132 and connecting portions 133. The common electrode 126 includes electrode films 156 to 158, which are mutually continuous. The electrophoretic display medium in the first modified example, in order to restrict further the movement of the charged particles between cells in the direction of the shorter side (the vertical direction in FIG. 20), has the configuration described below. Among the connecting portions 132, 133 that are arrayed in the direction of the longer side of the electrophoretic display medium that is indicated by the arrow 281 (the horizontal direction in FIG. 20), the number of the connecting portions 132 is less than the number of the connecting portions 32 in the first embodiment. In the connecting portions 132, the minimum distance on the plane between neighboring partition walls 113 is larger than the mean particle size of the charged particles. Specifically, the partition walls 113 include partition walls 115 that have cross-shaped planar forms and partition walls 114 that connect end portions of the partition walls 115 with the cross-shaped planar forms. The electrode films 158 are formed in the connecting portions 133, which are provided at the connecting points of the partition walls 114, and the electrode films 158 are electrically connected to the electrode films 156, which are formed in the cell portions 131. However, the widths of the gaps that are framed by the partition walls 113 in the connecting portions 133 are smaller than the mean particle size of the charged particles, so the charged particles cannot pass through the gaps. The partition walls 114 are arrayed in every other row in the direction of the shorter side of the electrophoretic display medium (the vertical direction in FIG. 20).

This sort of configuration makes it possible to lengthen the distances on the plane between some of the connecting portions 132 that are arrayed in the direction of the longer side of the electrophoretic display medium that is indicated by the arrow 281 (the horizontal direction in FIG. 20), the connecting portions 132 having gaps on the plane through which the charged particles can pass. The movement of the charged particles in that direction between the cells can therefore be more effectively restricted. The locations and the number of the elements that thus reduce the number of the connecting portions 132 through which the charged particles can pass may be determined in a regular manner, such as by providing them in every other row as in the first modified example, and they may also be determined in an irregular manner according to the directions and the locations where the movement of the charged particles between the cells is to be restricted. In addition, the directions in which the number of the connecting portions 132 through which the charged particles can pass is reduced, which are directions that correspond to the specified directions in the present disclosure, can be freely determined according to the shape and the use of the electrophoretic display medium, the form in which the user uses the electrophoretic display medium, and the like. Furthermore, in order to reduce the number of the connecting portions 132 through which the charged particles can pass, the widths on the plane of the gaps that are framed by the partition walls 113 in the connecting portions 132 can be made such that the charged particles cannot pass through the gaps, and the gaps can also be completely blocked. Note that the configuration of the partition walls 113 in the first modified example is achieved by performing a partition wall formation process using a forming die that includes recessed portions that correspond to the partition walls 113. In the forming die that is used, the specified directions in the present disclosure are the direction that corresponds to the longer side of the electrophoretic display medium and the direction that corresponds to the shorter side of the electrophoretic display medium. Further, in the forming die that is used to manufacture the electrophoretic display medium according to first modified example, the number of the linking portions that are arrayed in the direction that corresponds to the direction of the longer side of the manufactured electrophoretic display medium is less than the number of the linking portions in the forming die 40 that is used in the example described above. Thus, in order to reduce the number of the linking portions that correspond to the connecting portions 132 through which the charged particles can pass, the number of the linking portions may be reduced, and the distances between the recessed portions may also be made smaller than the mean particle size of the charged particles.

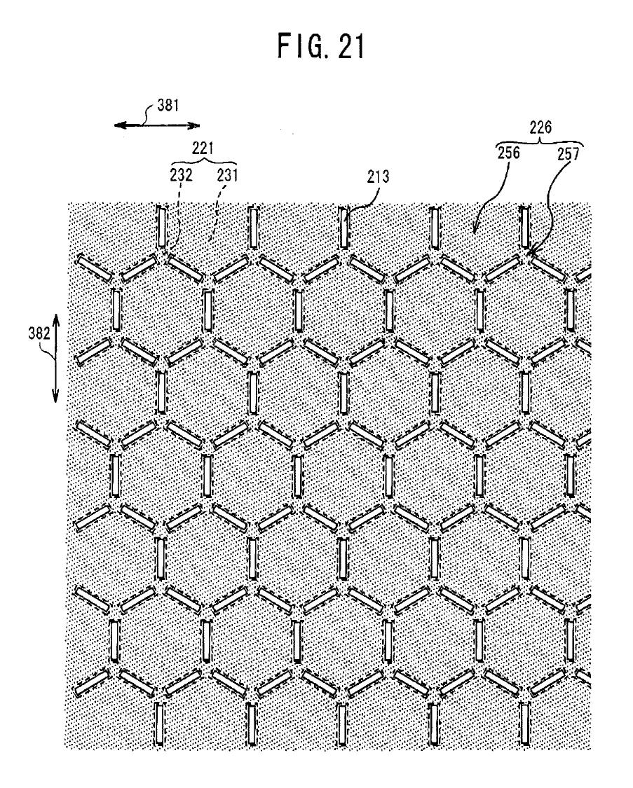

Next, the second modified example will be explained with reference to FIG. 21. In FIG. 21, the direction indicated by an arrow 381 is the direction of a longer side of an electrophoretic display medium according to the second modified example, and the direction indicated by an arrow 382 is the direction of a shorter side of the electrophoretic display medium according to the second modified example. As shown in FIG. 21, in the second modified example, partition walls 213 that have rectangular planar forms partition a space that is sandwiched between a first substrate and a second substrate into cells that have hexagonal planar forms. Electrode films 256 that have hexagonal planar forms and are provided within cell portions 231 are electrically connected to one another by electrode films 257 that are provided in connecting portions 232. A continuous common electrode 226 is thus formed on surfaces of on-wall portions 221 of the first substrate, which are made up of the cell portions 231 and the connecting portions 232. The shapes of the cells that are partitioned by the partition walls 213 are not limited to being square, as they are in the first modified example. Note that in the same manner as in the first modified example, the configuration of the partition walls 213 in the second modified example is achieved by performing a partition wall formation process using a forming die that includes recessed portions that correspond to the partition walls 213.

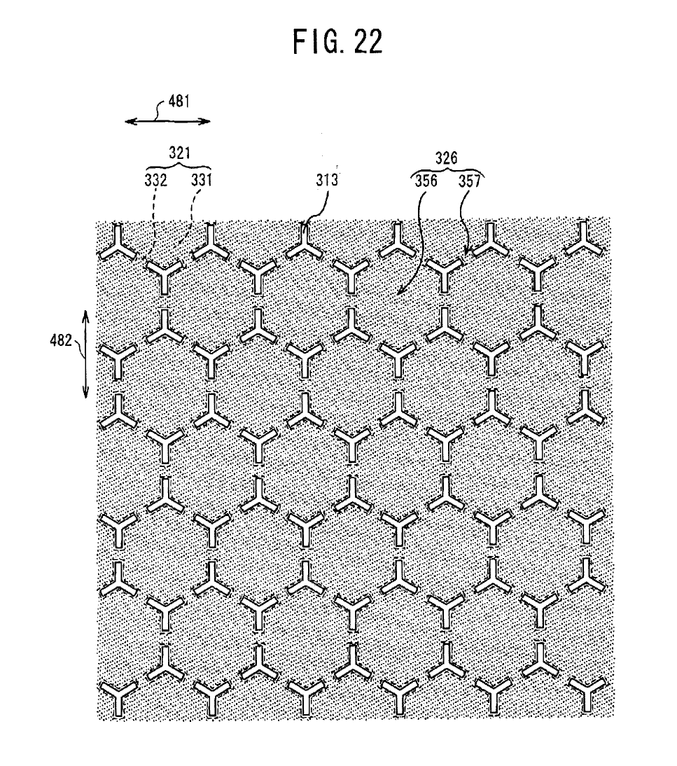

Next, the third modified example will be explained with reference to FIG. 22. In FIG. 22, the direction indicated by an arrow 481 is the direction of a longer side of an electrophoretic display medium according to the third modified example, and the direction indicated by an arrow 482 is the direction of a shorter side of the electrophoretic display medium according to the third modified example. As shown in FIG. 22, in the third modified example, partition walls 313 that have Y-shaped planar forms partition a space that is sandwiched between a first substrate and a second substrate into cells that have hexagonal planar forms, in the same manner as in the second modified example. In a case where the cells have polygonal planar forms, the connecting portions 232 may be provided at the vertices for the polygonal shapes, as they are in the second modified example, and connecting portions 332 may also be provided at any point on any side of the polygonal shapes, as they are in the third modified example. Electrode films 356 that have hexagonal planar forms and are provided within cell portions 331 are electrically connected to one another by electrode films 357 that are provided in connecting portions 332. A continuous common electrode 326 is thus formed as a single unit on surfaces of on-wall portions 321 of the first substrate, which are made up of the cell portions 331 and the connecting portions 332. In the case of the third modified example, the connecting portions 332 that are arrayed in the direction of the longer side of the electrophoretic display medium that is indicated by the arrow 481 (the horizontal direction in FIG. 22) are arranged such that they do not have the partition walls 313 between them. In a case where the electrophoretic display medium is not tilted when it is used, for example, the connecting portions may be arranged as they are in the third modified example, without the partition walls 313 between them. In the third modified example, the connecting portions 332 are provided on every side of every hexagonal shape, but the connecting portions may also be provided on only some of the sides. Therefore, the first modified example may be applied to the third modified example, such that the number of the connecting portions is reduced in a specified direction, thus restricting the movement of the charged particles in that direction. Furthermore, in the same manner as in the first modified example and the second modified example, the configuration of the partition walls 313 in the third modified example is achieved by performing a partition wall formation process using a forming die that includes recessed portions that correspond to the partition walls 313.

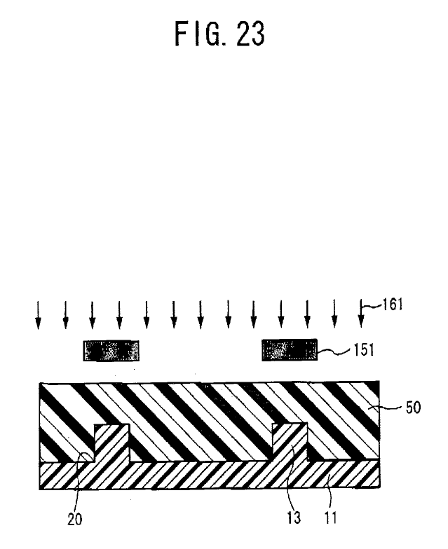

Next, a second embodiment of the manufacturing of the electrophoretic display medium 1 will be explained with reference to FIG. 23. In the second embodiment, after the resist film formation process described above in the electrode film formation process, a sand blasting process is performed in which sand blasting processing that uses abrasive particles leaves the resist films only on the outer edge portions of the partition walls 13. In the second embodiment, the processes other than the electrode film formation process are the same as in the first embodiment, so explanations of those processes will be omitted. Note that in the same manner as in the first embodiment, in order to explain the sand blasting process schematically, the configuring elements that are shown in FIG. 23 are shown with different dimensions than the corresponding configuring elements in the section view that is shown in FIG. 3.

In the first embodiment described above, the lithographic exposure process and the development process are performed after the resist film formation process in the electrode film formation process. In contrast, in the second embodiment, the sand blasting process that uses sand blasting processing to remove the resist film 50 everywhere but on the outer edge portions of the partition walls 13 and the spacer 14 is performed after the resist film formation process. In the sand blasting process, after the resist film formation process described above in the first embodiment, a mask 151 is placed on the tops of the outer edge portions of the partition walls 13 and the spacer 14, as shown in FIG. 23, and the sand blasting processing is performed using the abrasive particles. The locations where the mask 151 is placed are the tops of the parts where the resist film 50 will not be removed. The resist film in the locations where the mask 151 is not placed is removed by the abrasive particles that are discharged against the resist film 50 in the vertical direction indicated by arrows 161. The resist film therefore remains only on the outer edge portions of the partition walls 13 and the spacer 14, on the tops of which the mask 151 was placed. When the mask 151 is placed, it is positioned using the positioning marks, in the same manner as in the first embodiment, so the outer edge portions of the partition walls 13 and the spacer 14 are reliably covered. The amount of the resist film that is removed can be easily controlled by regulating the type of the abrasive particles (in terms of particle size, composition, density, hardness, and strength), the air pressure and angle at which the abrasive particles are discharged, the amount of the abrasive particles that are discharged, and the like. Note that in a case where the spacer 14 is formed separately from the first substrate 11 and the partition walls 13 and is not formed on the first substrate 11 prior to the electrode film formation process, it is acceptable for only the outer edge portions of the partition walls 13 to be covered by the resist films.

After the sand blasting process in the second embodiment, the electrode film formation process is performed in the same manner as in the first embodiment. The resist films that remain on the outer edge portions of the partition walls 13 after the sand blasting process, as well as the electrode films that were formed on top of the resist films, are then removed in the lift-off process. At this time, unlike in the first embodiment, the resist films that were formed on the outer edge portions of the partition walls 13 have not gone through the lithographic exposure process, so they can be removed using an ordinary developing fluid, even in a case where a negative type resist is used as the material for the resist films. Note that the processing conditions for the lift-off process are the same as in the first embodiment.

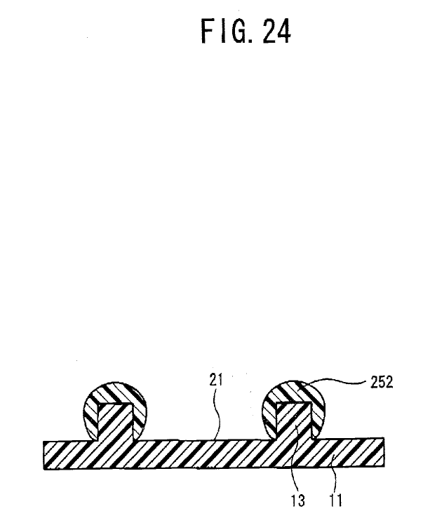

Next, a third embodiment of the manufacturing of the electrophoretic display medium 1 will be explained with reference to FIG. 24. When the electrophoretic display medium 1 is manufactured in the third embodiment, a resist coating process is performed in the electrode film formation process that uses an ink jet method to apply the resist directly only to the outer edge portions of the partition walls 13. Note that in the third embodiment, the processes other than the electrode film formation process are the same as in the first embodiment, so explanations of those processes will be omitted. In order to explain the resist coating process schematically, in the same manner as in the first embodiment, the configuring elements that are shown in FIG. 24 are shown with different dimensions than the corresponding configuring elements in the section view that is shown in FIG. 3, and only two of the partition walls 13 are shown.

In the first embodiment described above, the resist film formation process, the lithographic exposure process, and the development press are performed in the electrode film formation process, such that the masking resist films 52 are formed. In contrast, in the third embodiment, the resist films are formed by performing the resist coating process, which uses the ink jet method to apply the resist directly only to the outer edge portions of the partition walls 13. In the resist coating process, as shown in FIG. 24, resist films 252 are formed by using the ink jet method to apply the resist directly only to the locations where masking is required in the electrode film formation process, that is, the outer edge portions of the partition walls 13 and the spacer 14. The resist that forms the resist films 252 may be a positive type resist and may also be a negative type resist. In addition to making it possible to apply the resist only to the outer edge portions of the partition walls 13 and the spacer 14, the resist coating process also makes it possible to simplify the manufacturing process, because the resist films 252 can be formed on the outer edge portions of the partition walls 13 by a single process. The thicknesses of the resist films 252 can also be easily regulated. Note that in the same manner as in the second embodiment, in a case where the spacer 14 is formed separately from the first substrate 11 and the partition walls 13 and is not formed on the first substrate 11 prior to the electrode film formation process, it is acceptable for only the outer edge portions of the partition walls 13 to be covered by the resist films 252.

After the resist coating process in the third embodiment, the electrode film formation process is performed in the same manner as in the first embodiment. The resist films 252 that were formed on the outer edge portions of the partition walls 13 and the spacer 14 in the resist coating process, as well as the electrode films that were formed on top of the resist films 252, are then removed in the lift-off process. In the same manner as in the second embodiment, and unlike in the first embodiment, the resist films 252 that were formed on the outer edge portions of the partition walls 13 have not gone through the lithographic exposure process. They can therefore be removed using an ordinary developing fluid, even in a case where a negative type resist is used as the material for the resist films 252. Note that the processing conditions for the lift-off process are the same as in the first embodiment.

Next, a fourth embodiment of the manufacturing of the electrophoretic display medium 1 will be explained in which, in the electrode film formation process, an ink jet method is used to form the electrode film directly in the non-wall portions 21 of the first substrate 11. In the fourth embodiment, the processes other than the electrode film formation process are the same as in the first embodiment, so explanations of those processes will be omitted.

In the fourth embodiment, in the electrode film formation process, the ink jet method is used to form the electrode film directly in the non-wall portions 21 of the first substrate 11, without forming the resist films that cover the outer edge portions of the partition walls 13 as is done in the first to third embodiments described above. According to this method, the masking resist films are not formed on the outer edge portions of the partition walls 13 and the like to prevent the electrode film from being formed in locations other than the non-wall portions 21 of the first substrate 11. Instead, the electrode film can be formed only in the non-wall portions 21 of the first substrate 11. This method therefore makes it possible to form the continuous electrode film reliably using a simple processing process.

While the invention has been described in connection with exemplary embodiments, it will be understood by those skilled in the art that other variations and modifications of the exemplary embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being indicated by the flowing claims.

What is claimed is:

1. An electrophoretic display medium manufacturing method for manufacturing an electrophoretic display medium that includes a first substrate and a second substrate that are provided such that they face one another, the electrophoretic display medium manufacturing method comprising the steps of:
forming an unprocessed first substrate such that it conforms to recessed and protruding portions of a forming surface that is provided in a forming die, the unprocessed first substrate being formed from a synthetic resin and the forming die being pressed upon at least an inner face of the unprocessed first substrate, the inner face being a surface that faces the second substrate;
forming partition walls that are projecting portions that are provided on the inner face to partition a space that is sandwiched between the first substrate and the second substrate into a plurality of cells, the partition walls being formed by releasing the forming die from the first substrate; and
forming electrode films in non-wall portions that are parts of the inner face of the first substrate where the partition walls are not formed, such that the electrode films will apply an electrical field for moving charged particles that are enclosed within the cells.

2. The electrophoretic display medium manufacturing method according to claim 1, wherein
the synthetic resin contains a stimulus hardening resin that is hardened by an external stimulus.

3. The electrophoretic display medium manufacturing method according to claim 2, wherein
the stimulus hardening resin contains a thermoplastic resin,
the synthetic resin is formed such that it conforms to the recessed and protruding portions of the forming surface of the forming die, and
the synthetic resin is cooled in a state in which the forming die is pressed upon the synthetic resin.

4. The electrophoretic display medium manufacturing method according to claim 2, wherein
the stimulus hardening resin contains a thermosetting resin,
the synthetic resin is formed such that it conforms to the recessed and protruding portions of the forming surface of the forming die, and
the synthetic resin is heated in a state in which the forming die is pressed upon the synthetic resin.

5. The electrophoretic display medium manufacturing method according to claim 2, wherein
the stimulus hardening resin contains an ultraviolet light hardening resin,
the synthetic resin is formed such that it conforms to the recessed and protruding portions of the forming surface of the forming die, and
the synthetic resin is irradiated with ultraviolet light in a state in which the forming die is pressed upon the synthetic resin.

6. The electrophoretic display medium manufacturing method according to claim 1, further comprising the steps of:
forming a resist film that covers at least the partition walls on the inner face of the first substrate;
irradiating the resist film with light such that the resist film on outer edge portions of the partition walls is put into a state in which it cannot be dissolved by a developing fluid;
removing the resist film that has not been put into the insoluble state;
forming the electrode films in at least the non-wall portions of the first substrate where the resist film has been removed; and
removing the electrode films that have been formed on top of the resist film on the outer edge portions of the partition walls, as well as the resist film on the outer edge portions of the partition walls.

7. The electrophoretic display medium manufacturing method according to claim 1, further comprising the steps of:
forming a resist film that covers at least the partition walls on the inner face of the first substrate;
removing the resist film that is not on outer edge portions of the partition walls, using sand blasting processing that uses abrasive particles and a mask;
forming the electrode films in at least the non-wall portions of the first substrate where the resist film has been removed; and
removing the electrode films that have been formed on top of the resist film on the outer edge portions of the partition walls, as well as the resist film on the outer edge portions of the partition walls.

8. The electrophoretic display medium manufacturing method according to claim 1, further comprising the steps of:
forming a resist film that covers at least outer edge portions of the partition walls, using an ink jet method;
forming the electrode films in at least the non-wall portions of the first substrate; and
removing the electrode films that have been formed on top of the resist film that was formed on the outer edge portions of the partition walls, as well as the resist film on the outer edge portions of the partition walls.

9. The electrophoretic display medium manufacturing method according to claim 1, wherein
the electrode films are formed in the non-wall portions of the first substrate by an ink jet method.

10. The electrophoretic display medium manufacturing method according to claim 1, wherein
the electrode films are transparent electrode films.

11. The electrophoretic display medium manufacturing method according to claim 1, wherein
top faces of the protruding portions of the forming die that correspond to the non-wall portions of the first substrate are top faces in the direction of protrusion and are continuous.

12. The electrophoretic display medium manufacturing method according to claim 1, wherein
top faces of the protruding portions of the forming die that correspond to the non-wall portions of the first substrate that are top faces in the direction of protrusion include
cell corresponding portions that correspond to cell portions that are portions that form the cells in the non-wall portions, and
linking portions that correspond to connecting portions that connect a plurality of
the cell portions in the non-wall portions,
and
the linking portions for which a distance between the recessed portions, which is a minimum distance between the recessed portions that surround the linking portions and that are adjacent to one another, is not less than a mean particle size of the charged particles are arrayed in a specified direction such that the linking portions have between them at least one of one of the recessed portions of the forming die and one of the linking portions for which the distance between the recessed portions is less than the mean particle size of the charged particles.

13. The electrophoretic display medium manufacturing method according to claim 12, wherein
the specified direction is a direction that corresponds to at least one of a direction of a longer side of the electrophoretic display medium and a direction of a shorter side of the electrophoretic display medium.

14. An electrophoretic display medium that is manufactured by one of the electrophoretic display medium manufacturing methods that are described in claim 1.

15. An electrophoretic display device, comprising:
the electrophoretic display medium that is described in claim 14.
